(19) United States
(12) Patent Application Publication
(10) Pub. No.: US 2010/0107726 A1
(43) Pub. Date: May 6, 2010

(54) DEVICE FOR DETERMINING THE COEFFICIENT OF FRICTION OF DIAMOND CONDITIONER DISCS AND A METHOD OF USE THEREOF

(75) Inventors: Leonard Borucki, Mesa, AZ (US); Naoki Rikita, Tokyo (JP); Ara Philipossian, Tucson, AZ (US); Fransisca Maria Astrid Sudargho, Tucson, AZ (US); Yun Zhuang, Tucson, AZ (US)

Correspondence Address: EDWARDS ANGELL PALMER & DODGE LLP, P.O. BOX 55874, BOSTON, MA, 02205, US

(73) Assignees: Mitsubishi Materials Corporation, Tokyo (JP); Araca Inc., Tucson, AZ (US)

(21) Appl. No.: 12/262,974

(22) Filed: Oct. 31, 2008

(51) Int. Cl. G01N 19/02

(52) U.S. Cl. 73/9

(57) ABSTRACT

A device for determining the coefficient of friction of diamond conditioner discs and a method of use thereof. The device is a solid base means comprising a block of granite with a smooth flat upper surface, a diamond conditioner disc counter surface means comprising a removable sheet of polycarbonate, a means for moving the diamond conditioner disc comprising an assembly parallel to and perpendicular to the surface of the said slab and overlain material along which a plate, the surface of which is parallel to the surface of the assembly and perpendicular to the surface of the said slab and overlain material, is moved by a screw, a means for securing the diamond conditioner disc comprising a holder bolted to the said plate that is capable of riding just above the surface of the slab and overlain material with an anterior face with respect to the direction of motion that is concave and capable of securely holding a diamond conditioner disc placed grinding face down upon the said overlain material the top of which is open so that load may be applied to the diamond conditioner disc and a means for measuring the shear force imparted by the moving diamond conditioner disc comprising a load cell. Shear force and down force are determined using the above apparatus and the coefficient of friction of the diamond conditioner disc and the said sheet are calculated therefrom.

### FIELD OF THE INVENTION

The present invention relates to a device for measuring the coefficient of friction of diamond conditioner discs and methods of using the same.

### BACKGROUND OF THE INVENTION

Diamond conditioner discs have been used in CMP processes to great effect to maintain the roughness of polyurethane polishing pads. These discs have been produced and marketed by several vendors to standards of reliable quality and effectiveness. Generally, diamond conditioner discs are evaluated based on, among other things, the total number of diamonds present on the surface of the disc and the number of diamonds remaining after certain specified periods of use or environmental testing. This number will in turn relates to the effectiveness of the diamond conditioner disc in wearing away the surface of the polyurethane CMP pad during CMP processes. Another way of determining this effectiveness is to consider the coefficient of friction of the diamond conditioner disc. Such a method takes into account not only the effect of the number of active diamonds but their positioning, size, roughness and any other factors involved in the wear of the polyurethane pad by the diamond conditioner disc.

To date no such method for consistently determining the coefficient of friction of diamond conditioner discs has been disclosed.

Heretofore, those skilled in the art who desired to know the coefficient of friction of a diamond conditioner disc, were able to determine it by methods available to the prior art under certain conditions. In 2003, Mark Bubnick, Ph.D. and Sohail Qamar Abrasive Technology, in a paper published in Abrasive Technology TECHVIEW (http://www.abrasive-tech.com/pdf/temptungsten.pdf) disclosed a method of measuring the coefficient of friction of diamond conditioner discs using “Abrasive Technology's cut-rate tester using Rodel ICI1000 pads in deionised water.” However, this procedure, involved complex setup, expensive materials and it does not appear that it is possible to determine the coefficient of the disc at a single moment in time or for a single orientation.

Users of diamond conditioner discs need to know that they are receiving the same quality of product from diamond conditioner disc manufacturers from the standpoint of process effectiveness on a consistent basis and such a test would allow users to better determine specifications for what they require. Users may also want to know how well their disc are faring under certain operating conditions and an accurate method of determining the coefficient of friction of diamond conditioner discs will provide them with useful information in that regard. Finally, from a research and development standpoint, the results of such a test would provide makers of diamond conditioner discs with more useful information about how to improve existing manufacturing processes for diamond conditioner discs or in the development of new CMP and related processes.

The present invention seeks to provide an accurate and consistent method for determining the coefficient of friction of diamond conditioner discs. These and other advantages of the invention will be apparent from the description of the invention provided herein.

### BRIEF SUMMARY OF THE INVENTION

The present invention provides a device for measuring the coefficient of friction of a diamond conditioning disc for use in CMP processing and a method for use thereof. In particular this device comprises a solid base means, a diamond conditioner disc dragging counter surface means on top of the said solid base means, both solid base means and diamond conditioner disc counter surface means having a length sufficient to allow transverse motion of the diamond conditioner disc for measurement of the coefficient of friction, a means for moving the diamond conditioner disc along the diamond conditioner disc counter surface, a means for securing the diamond conditioner disc within the said means for moving the diamond conditioner disc along the diamond conditioner disc counter surface, a means for driving the said means for moving the diamond conditioner disc along the diamond conditioner disc counter surface and a means for measuring the force applied to the diamond conditioner disc. There may additionally be a means for measuring the velocity of the movement of the diamond conditioner disc. The method for measuring the coefficient of friction using the device of the present invention comprises placing the diamond conditioner disc in means for securing the diamond conditioner disc within the means for moving the said diamond conditioner disc so that the rough face that contacts the CMP pad during CMP processing is face down and in contact with the upper surface of the diamond conditioner disc dragging counter surface means on top of the said solid base means, moving the said diamond conditioner disc using the means for driving the diamond conditioner moving means and measuring and force required using the means for measuring the force applied to the diamond conditioner disc. The velocity may also be measured using the means for measuring the velocity.

### BRIEF DESCRIPTION OF THE DRAWINGS

FIG. 1 is a side view of the device for the measurement of the coefficient of friction of diamond conditioner discs of the present invention;

FIG. 2 is a view from above of the device for the measurement of the coefficient of friction of diamond conditioner discs of the present invention; and

FIG. 3 is an end view of the device for the measurement of the coefficient of friction of diamond conditioner discs of the present invention.

### DETAILED DESCRIPTION OF THE INVENTION

In the present disclosure, forward and backward shall refer to the direction which the conditioner disc moves during the measurement of the coefficient and the reverse direction respectively.

The inventors of the present invention, in order to solve the problem of easily and cost effectively measuring the coefficient of diamond conditioner discs either in an unused state or after a period of use have as a result of systematic and prolonged study of the problem of reliably providing a method that would obtain convenient and consistent results for the coefficient of friction of chemical mechanical polishing use diamond conditioner discs have developed the present invention.

More particularly, they have prepared a device for measuring the coefficient of friction of diamond conditioner discs for use in CMP polishing at various speeds and loads comprising a solid base means, a diamond conditioner disc dragging counter surface means on top of the said solid base means, both solid base means and diamond conditioner disc counter surface means having a length sufficient to allow transverse motion of the diamond conditioner disc for measurement of the coefficient of friction, a means for moving the diamond conditioner disc along the diamond conditioner disc counter surface, a means for securing the diamond conditioner disc within the said means for moving the diamond conditioner disc along the diamond conditioner disc counter surface, a means for driving the said means for moving the diamond conditioner disc along the diamond conditioner disc counter surface and a means for measuring the force applied to the diamond conditioner disc. A means for measuring the velocity of the movement of the diamond conditioner disc may also be a part of the present invention.

In addition they have devised a method for measuring the coefficient of friction of diamond conditioner discs for use in CMP polishing at various speeds and loads using a device comprising a solid base means, a diamond conditioner disc dragging counter surface means on top of the said solid base means, both solid base means and diamond conditioner disc counter surface means having a length sufficient to allow transverse motion of the diamond conditioner disc for measurement of the coefficient of friction, a means for moving the diamond conditioner disc along the diamond conditioner disc counter surface, a means for securing the diamond conditioner disc within the said means for moving the diamond conditioner disc along the diamond conditioner disc counter surface, a means for driving the said means for moving the diamond conditioner disc along the diamond conditioner disc counter surface and a means for measuring the force applied to the diamond conditioner disc. A means for measuring the velocity of the movement of the diamond conditioner disc may also be included in the device used for the method of the present invention.

The apparatus of the present invention has been developed in response to the present state of the art, and in particular, in response to the problems and needs in the art that have not yet been fully solved by currently available devices and methods by which the coefficient of friction of diamond conditioning discs can be measured. Thus, it is an overall objective of the present invention to provide devices for the measurement of the coefficient of friction of CMP use diamond conditioner discs and related methods that remedy the shortcomings of the prior art.

The purpose of this device and method are to allow more effective measurement of the coefficient of friction of diamond conditioner discs used to roughen CMP pads during operation. Diamond conditioner discs are covered with large numbers of very small diamonds and in addition to any inherent frictional characteristic of the matrix in which the diamonds are set possess a component of the coefficient of friction resulting from the action of the individual diamonds scratching through the CMP pad. Since the coefficient of friction is actually not the component of one material in one surface but the composite system of two possibly distinct surfaces interacting with each other, it is important for purposes of determining the coefficient of friction of the diamond conditioner disc that the other material be similar in hardness to the polyurethane material used in the discs of CMP processing. Either polycarbonate sheet or polyurethane material meet this criteria and it was observed that polycarbonate sheets of a very high degree of smoothness are readily available at low cost.

The true coefficient of friction involves the microscopic properties of the two surfaces of the system, the surface of the diamond conditioner disc and the surface it is in contact with. However, for the purposes for which this property is being measured in the diamond conditioner discs, the effect of the diamonds, particularly those situated in such a way as to be able to scratch the surface facing the disc are of paramount importance. Since the same sheet, whether polycarbonate or polyurethane or other suitable material must be consistently used, the only changes reflected in changes in the coefficient of friction data obtained can be attributed to the difference in number, placement or quality of the diamonds set in the disc at the outset and less directly the wearing down of the diamonds on the disc as it is used. Notably there are subtle variations in the coefficient of a single disc itself as it is rotated with respect to the direction of transverse motion used during measurement.

The formula for coefficient of friction is equal to the load on the surfaces divided by the frictional force. Velocity and temperature exert an influence on coefficient of friction and should be fixed constant to result in coefficient of friction data that are comparable between different discs or the same discs at different times. Surface area should not be a factor for discs with the same surface area but would be a factor for different sized discs. The fundamental function of this device and method provide a value for frictional force which is composed largely of the force of diamonds scratching into the polycarbonate or polyurethane surface and resisting forward motion of the disc. Ultimately since the load on the disc is known and other factors such as surface area, disc velocity and temperature are or can be maintained constant, a consistent reproducible figure for the coefficient of friction of a disc that can be compared with the corresponding figure for other discs or the same disc that has undergone further wear can be obtained.

Manufacturers and users of diamond conditioner discs need to know how rough the diamond conditioner discs are and by extension how capable of roughening the CMP pads they are. They also need to know how much variation there is between discs and it is even desirable to know if single discs are consistent in their roughening properties in which ever direction they are moved across the pad (Though rotation would minimize the overall effect of a difference in this characteristic, it is nonetheless a characteristic of the diamond conditioner disc). It is further desirable to know how quickly the effectiveness of the diamond conditioner disc is altered by use, generally or under particular conditions.

The present invention overcomes the limitations of the prior art by providing a quick and easy method to measure a large number of diamond conditioner discs or the same disc or discs many times in a short time and to determine the coefficient of friction of the disc, a characteristic that bears directly upon its ability to wear and roughen CMP pads, with a simple calculation dividing the normal or “down” force by the frictional or in this case the “shear” force. The design of the present invention makes the control of various factors such as temperature, velocity of the diamond conditioner disc, flatness and material consistency of the surface contacting the diamond disc, load and the like very easy. The device is essentially a flat very stable surface over which is lain a sheet of material having hardness properties the same or near to those of the polyurethane used in CMP pads, a device for moving the pad across this sheet and some way of measuring the force imparted to the sheet and surface as the diamond conditioning disc passes. In this way, the normal or down force is known by calculation from the mass of the diamond conditioner disc plus any added load, the frictional force is obtained and the two are divided to yield the coefficient of friction of the diamond conditioner disc.

All dimensions for parts in the present invention follow are based on a diamond conditioner disc size of 3 inches in diameter and may be altered as needed in proportion to changes in the size of the sample used. The specific dimensions given herein are in no way limiting but are by way of example to demonstrate an effective embodiment of the invention.

As the solid base means of the present invention naturally any solid base capable or remaining stable and undistorted, that is easily polished to a precise flat finish that is not easily marred, does not alter shape significantly with change in temperature, and neither generates or transmits vibration excessively during operation may be used, and a hard massive stone, ceramic, metallic or plastic composite material is preferred, a polished stone block is more preferred. As the stone of the polished stone block, the type of stone is not particularly limited and any stone with high density and structural integrity that can hold a hard polished surface may be used but granite, gabbro, pegmatite, diorite, basalt, and the like are preferred and granite is more preferred. As the dimensions of the solid base means, any lateral dimensions wide enough to securely encompass the diamond conditioner disc may be used and it is preferred that the lateral dimension be at least 4 inches. The length of the solid base means is not particularly limited, however, it should be great enough to allow sufficient transverse movement of the diamond conditioner disc to obtain a reading of the frictional force by the shear force measuring means. A length of at least 18 inches is preferred. The thickness of the solid base means is not particularly limited and a minimum thickness of about half an inch is preferred. However, if all of the dimensions of the solid base means are too large, the mass may be so great as to impede the operation of the device in applying shear force to the means for measuring the shear force. Therefore, in principle, the dimensions and resulting mass of the solid base means should be no larger than is necessary to provide a stable smooth surface for operation and to allow the length of diamond conditioner disc motion desired by the user.

As the diamond conditioner disc dragging counter surface means on top of the said solid base means, any hard material with an extremely smooth flat surface that may be scratched by the diamonds in a diamond conditioner disc may be used and a hard material having the same hardness index as the polyurethane is preferred. Polycarbonate sheet which may be easily purchased from the home hardware market in essentially very flat smooth form is more preferred. This means is attached to the solid base means by any suitable means but a clamp is preferred.

As the means for moving the diamond conditioner disc along the diamond conditioner disc counter surface, any means capable of moving the disc along the surface is permitted and a transverse driven by a motor with a screw, chain, hydraulic or other fluid, or electromagnetic mechanism may be used. A transverse driven by a screw with a threaded block to which the means for securing the diamond conditioner disc is to be attached is preferred.

As the means for securing the diamond conditioner disc within the said means for moving the diamond conditioner disc along the counter surface, any suitable means of securing the diamond conditioner disc to the said means for moving the diamond conditioner disc may be used. A concave structure made of plastic, ceramic, metal or other hard material attached to the means for moving the diamond conditioner disc along the diamond conditioner disc counter surface is preferred. The dimensions of such a structure may be any dimensions suitable to holding the diamond conditioner disc and a concave diameter of 3 inches is preferable. As the dimension for the height, any suitable dimension that will allow certain loads to be added to the top of the diamond conditioner disc may be used but a height of about 1.5 inches is preferred.

As the means for driving the said means for moving the diamond conditioner disc along the diamond conditioner disc counter surface, any suitable means may be used and a stepper motor attached to the transverse screw assembly by cable is preferred.

As the means for measuring the velocity of the movement of the diamond conditioner disc, any means including sensors and timers that record how long the diamond conditioner disc required to move between set points may be used and a software program that calculates the velocity of the disc based on the rapidity of motor or screw rotation is preferred.

As the means for measuring the shear force imparted by the moving diamond conditioner disc any reasonable means may be applied. However, a means comprising a plate riding on rails or wheels on a lower plate or surface by means of rails, wheels or guides, which plate lies under and supports the solid base means and to which a load sensor that detects the force exerted on the upper plate by the motion and friction of the diamond conditioner disc on the diamond conditioner disc counter surface and solid base means is preferred. The plate or plates may be made of any structurally durable material that does not easily undergo distortion of its shape under 100 pounds of load and steel plates are preferred. Any means of attaching the load sensor between the two plates may be used, but a downward protrusion from the top plate at right angles to the surface of the plate to which the load cell is bolted and a protrusion from the lower plate or surface to which contacts the sensory portion of the load cell is preferred. Guide blocks may also be attached to the top plate and lower plates respectively that extend across substantially more than half the distance between the two places with adjoining faces treated to minimize friction aligned in the direction of motion of the runners and the diamond conditioner disc to serve as guides may also be used.

As runners for the present invention any suitable system of runners may be used but a set of two runners running the length of the plates in the direction of motion of the diamond conditioner disc on each side of the upper plate attached to it and held by two or more pillow blocks per runner attached to the bottom surface or plates, said pillow blocks and runners' surfaces having been treated or coated with anti-friction materials are preferred.

The load sensors may be attached by any suitable means but attachment to the upper protrusion by means of two half inch bolts is preferred.

As to the method of operation of the present invention, any suitable operation method may be used but after measuring the temperature and humidity of the surroundings, placing a diamond conditioner disc in the means for securing the diamond conditioner disc face down and adding a known load between 0 and 11 pounds additional to the mass of the diamond conditioner disc and then moving the diamond conditioner disc down the length of the diamond conditioner disc counter surface at [ ] inches per second and recording the shear force is preferred. The coefficient of friction is calculated by dividing the load (including the weight of the diamond conditioner disc) by the load detected on the center. The disc is rotated (preferably 90 degrees) and the test is run again until four orientations are taken. More or fewer orientations may be taken as the operator desires. The diamond conditioning disc counter surface should be replaced between each run. Repeated tests can be made of the same disc at different points in its use life or tests may be made on a large number of discs of the same type from the same manufacturer. Sensory data for velocity and shear force may be output in graphical form and software may be used to calculate the coefficient of friction from the data of a run. Data may be transmitted from the sensors by cable or wireless antennae or any suitable means.

### PRACTICE EXAMPLES

### Example 1

Two steel sheets ¼ inch thick having dimensions of 18 inches by 30 inches are made into an upper plate [10] and a lower plate [12], the lower plate is bolted to a solid table surface [44] and 4 pillow blocks [14] are bolted to the upper face of the lower plate [10]. Four runner holders [16] are attached along the same lines to the bottom of the upper plate [10] and two runners [18] are fixed within them. The runners [18] are fixed within the pillow blocks [14] so that they can slide freely at least a short distance in the direction of motion of the runners [16]. A upward protruding attachment [20] is attached to the forward edge [22] of the lower plate [12] and an downward protruding attachment [24] is attached to the forward edge [26] of the upper plate [10] so that the vertical edges almost contact. The load cell [28] is attached to the downward protruding attachment [20] by two half inch bolts [30] and the sensory portion of the load cell [32] is placed so that it contacts the upward protruding attachment [24]. A half inch bolt [34] is provided to secure the load cell [28] there so that movement will not damage the load cell [28] when the device is not in use.

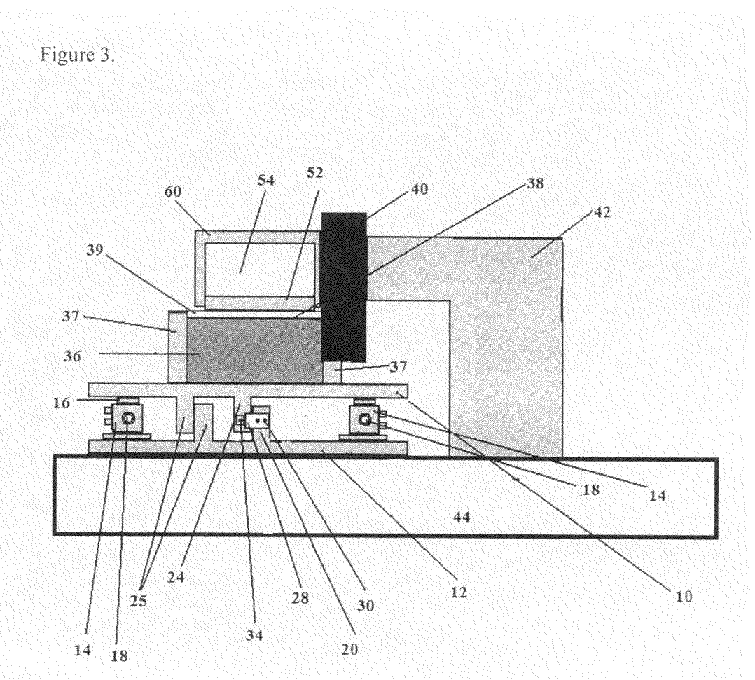

A block of polished granite [36] with a polished, smooth, level and horizontal upper surface [38] and dimensions of 2 feet by 6 inches by 2 inches is affixed by seating guides [37] to the upper surface of the upper plate [10]. On top of the said granite block surface [38] is laid a polycarbonate sheet [39] 0.093 inch thick and having the same lateral dimensions as the granite block [38]. Several of these sheets were prepared in advance of the test. The sheet [39] was affixed using clamps (not shown). A transverse [40] was attached to the solid table surface [44] by means of a support structure [42] bolted to the surface [44] holding the lower plate [12] by bolts (not shown) in the form described in FIG. 3. To the end of the transverse [40] a cable attachment [46] is attached and the transverse [40] linked by cable to a stepper motor (not shown). The screw [41] of the transverse [40] passes through a threaded block [48] that is supported by and slides along the transverse [40]. This block [48] in turn is attached to the side of and supports the concave surface [50] that secures the diamond conditioning disc [52]. Atop the diamond conditioning disc [52] are lain weights [54] so that the total weight of diamond conditioning disc and weights is 6.1 lbs. The precise rotational position of the diamond conditioning disc [52] with respect to the concave surface [50] is observed and noted.

When the weights [54] have been placed, the stepper motor is set so that the block [48] on the transverse [40] moves at a velocity of 0.246 meters per minute and the diamond conditioning disc [52] is moved the length of the transverse [40]. The load from the load cell [28] representing shear force from the movement of the diamond conditioning disc is recorded and output in graphical form. The average coefficient of friction over the run and standard deviation are calculated from this data.

### Example 2

Everything was carried out exactly as in Example 1 except that the orientation of the diamond conditioning disc with regard to the direction of motion was rotated forty five (45) degrees.

### Examples 3-64

Represent changes in disc, forty five degree changes in orientation, and load as indicated. The results for examples 1-64 Are shown in Tables 1 through 16 below:

TABLE 1
Disc 979926-05-1

| | | Down | Veloc- | Shear | | | |
|---|---|---|---|---|---|---|---|
| | Orien- | Force | ity | Force (lb_{f}) | | COF | |
| Run | tation | (lbf) | (m/min) | Average | STDEV | Average | STDEV |
| 1 | 1 | 6.1 | 0.246 | 4.02 | 0.12 | 0.659 | 0.019 |
| 2 | 1 | 6.1 | 0.246 | 3.86 | 0.12 | 0.632 | 0.019 |
| 3 | 2 | 6.1 | 0.246 | 3.91 | 0.11 | 0.642 | 0.018 |
| 4 | 2 | 6.1 | 0.246 | 3.76 | 0.12 | 0.616 | 0.020 |
| 5 | 3 | 6.1 | 0.246 | 3.99 | 0.10 | 0.653 | 0.017 |
| 6 | 3 | 6.1 | 0.246 | 3.87 | 0.12 | 0.634 | 0.019 |
| 7 | 4 | 6.1 | 0.246 | 3.94 | 0.13 | 0.646 | 0.021 |
| 8 | 4 | 6.1 | 0.246 | 3.89 | 0.11 | 0.638 | 0.019 |
| 9 | 5 | 6.1 | 0.246 | 3.85 | 0.15 | 0.631 | 0.025 |
| 10 | 5 | 6.1 | 0.246 | 3.86 | 0.13 | 0.633 | 0.022 |
| 11 | 6 | 6.1 | 0.246 | 3.96 | 0.19 | 0.649 | 0.031 |
| 12 | 6 | 6.1 | 0.246 | 3.90 | 0.21 | 0.640 | 0.034 |
| 13 | 7 | 6.1 | 0.246 | 4.04 | 0.17 | 0.663 | 0.027 |
| 14 | 7 | 6.1 | 0.246 | 4.06 | 0.15 | 0.665 | 0.024 |
| 15 | 8 | 6.1 | 0.246 | 3.90 | 0.22 | 0.640 | 0.036 |
| 16 | 8 | 6.1 | 0.246 | 3.68 | 0.18 | 0.603 | 0.029 |

TABLE 2
Disc 979926-05-1

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 17 | 1 | 6.1 | 0.493 | 4.02 | 0.13 | 0.660 | 0.021 |
| 18 | 1 | 6.1 | 0.493 | 3.95 | 0.17 | 0.648 | 0.029 |
| 19 | 2 | 6.1 | 0.493 | 4.28 | 0.21 | 0.702 | 0.034 |
| 20 | 2 | 6.1 | 0.493 | 4.04 | 0.22 | 0.662 | 0.036 |
| 21 | 3 | 6.1 | 0.493 | 4.03 | 0.15 | 0.660 | 0.025 |
| 22 | 3 | 6.1 | 0.493 | 3.98 | 0.16 | 0.653 | 0.027 |
| 23 | 4 | 6.1 | 0.493 | 4.12 | 0.25 | 0.675 | 0.040 |
| 24 | 4 | 6.1 | 0.493 | 4.09 | 0.25 | 0.670 | 0.041 |
| 25 | 5 | 6.1 | 0.493 | 3.94 | 0.19 | 0.646 | 0.032 |
| 26 | 5 | 6.1 | 0.493 | 4.11 | 0.23 | 0.674 | 0.037 |
| 27 | 6 | 6.1 | 0.493 | 3.95 | 0.21 | 0.648 | 0.035 |
| 28 | 6 | 6.1 | 0.493 | 3.99 | 0.18 | 0.654 | 0.029 |
| 29 | 7 | 6.1 | 0.493 | 4.08 | 0.12 | 0.669 | 0.020 |
| 30 | 7 | 6.1 | 0.493 | 4.06 | 0.17 | 0.665 | 0.028 |
| 31 | 8 | 6.1 | 0.493 | 4.06 | 0.24 | 0.666 | 0.040 |
| 32 | 8 | 6.1 | 0.493 | 3.90 | 0.15 | 0.640 | 0.024 |

TABLE 3
Disc 979926-05-1

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 33 | 1 | 12 | 0.246 | 8.18 | 0.35 | 0.682 | 0.029 |
| 34 | 1 | 12 | 0.246 | 8.04 | 0.30 | 0.670 | 0.025 |
| 35 | 2 | 12 | 0.246 | 8.20 | 0.43 | 0.683 | 0.036 |
| 36 | 2 | 12 | 0.246 | 8.35 | 0.36 | 0.696 | 0.030 |
| 37 | 3 | 12 | 0.246 | 8.39 | 0.47 | 0.699 | 0.039 |
| 38 | 3 | 12 | 0.246 | 8.29 | 0.36 | 0.691 | 0.030 |
| 39 | 4 | 12 | 0.246 | 8.16 | 0.44 | 0.680 | 0.036 |
| 40 | 4 | 12 | 0.246 | 8.37 | 0.29 | 0.697 | 0.024 |
| 41 | 5 | 12 | 0.246 | 8.39 | 0.40 | 0.699 | 0.033 |
| 42 | 5 | 12 | 0.246 | 8.31 | 0.45 | 0.693 | 0.038 |
| 43 | 6 | 12 | 0.246 | 8.55 | 0.40 | 0.712 | 0.033 |
| 44 | 6 | 12 | 0.246 | 8.00 | 0.38 | 0.667 | 0.032 |
| 45 | 7 | 12 | 0.246 | 8.09 | 0.28 | 0.674 | 0.023 |
| 46 | 7 | 12 | 0.246 | 8.70 | 0.42 | 0.725 | 0.035 |
| 47 | 8 | 12 | 0.246 | 8.37 | 0.27 | 0.698 | 0.022 |
| 48 | 8 | 12 | 0.246 | 8.34 | 0.29 | 0.695 | 0.024 |

TABLE 4
Disc 979926-05-1

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 49 | 1 | 12 | 0.493 | 8.74 | 0.52 | 0.728 | 0.044 |
| 50 | 1 | 12 | 0.493 | 8.59 | 0.27 | 0.716 | 0.023 |
| 51 | 2 | 12 | 0.493 | 8.27 | 0.27 | 0.689 | 0.023 |
| 52 | 2 | 12 | 0.493 | 8.68 | 0.37 | 0.723 | 0.031 |
| 53 | 3 | 12 | 0.493 | 8.56 | 0.42 | 0.713 | 0.035 |
| 54 | 3 | 12 | 0.493 | 8.52 | 0.54 | 0.710 | 0.045 |
| 55 | 4 | 12 | 0.493 | 8.02 | 0.42 | 0.668 | 0.035 |
| 56 | 4 | 12 | 0.493 | 8.24 | 0.50 | 0.686 | 0.042 |
| 57 | 5 | 12 | 0.493 | 8.14 | 0.40 | 0.679 | 0.033 |
| 58 | 5 | 12 | 0.493 | 8.23 | 0.41 | 0.686 | 0.034 |
| 59 | 6 | 12 | 0.493 | 8.26 | 0.36 | 0.688 | 0.030 |
| 60 | 6 | 12 | 0.493 | 8.26 | 0.31 | 0.688 | 0.026 |
| 61 | 7 | 12 | 0.493 | 8.68 | 0.33 | 0.723 | 0.027 |
| 62 | 7 | 12 | 0.493 | 8.32 | 0.34 | 0.694 | 0.028 |
| 63 | 8 | 12 | 0.493 | 8.47 | 0.29 | 0.706 | 0.024 |
| 64 | 8 | 12 | 0.493 | 8.34 | 0.35 | 0.695 | 0.029 |

TABLE 5
Disc 979926-05-2

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 1 | 1 | 6.1 | 0.246 | 4.51 | 0.11 | 0.739 | 0.018 |
| 2 | 1 | 6.1 | 0.246 | 4.56 | 0.08 | 0.748 | 0.012 |
| 3 | 2 | 6.1 | 0.246 | 4.40 | 0.08 | 0.721 | 0.013 |
| 4 | 2 | 6.1 | 0.246 | 4.47 | 0.08 | 0.734 | 0.013 |
| 5 | 3 | 6.1 | 0.246 | 4.44 | 0.08 | 0.727 | 0.014 |
| 6 | 3 | 6.1 | 0.246 | 4.32 | 0.09 | 0.709 | 0.014 |
| 7 | 4 | 6.1 | 0.246 | 4.53 | 0.08 | 0.742 | 0.014 |
| 8 | 4 | 6.1 | 0.246 | 4.32 | 0.07 | 0.709 | 0.012 |
| 9 | 5 | 6.1 | 0.246 | 4.48 | 0.12 | 0.734 | 0.019 |
| 10 | 5 | 6.1 | 0.246 | 4.18 | 0.10 | 0.686 | 0.016 |
| 11 | 6 | 6.1 | 0.246 | 4.53 | 0.12 | 0.743 | 0.019 |
| 12 | 6 | 6.1 | 0.246 | 4.38 | 0.13 | 0.718 | 0.021 |
| 13 | 7 | 6.1 | 0.246 | 4.50 | 0.13 | 0.737 | 0.021 |
| 14 | 7 | 6.1 | 0.246 | 4.33 | 0.18 | 0.710 | 0.030 |
| 15 | 8 | 6.1 | 0.246 | 4.79 | 0.21 | 0.785 | 0.034 |
| 16 | 8 | 6.1 | 0.246 | 4.82 | 0.20 | 0.790 | 0.033 |

TABLE 6
Disc 979926-05-2

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 17 | 1 | 6.1 | 0.493 | 4.62 | 0.19 | 0.757 | 0.031 |
| 18 | 1 | 6.1 | 0.493 | 4.54 | 0.22 | 0.745 | 0.036 |
| 19 | 2 | 6.1 | 0.493 | 4.58 | 0.25 | 0.750 | 0.041 |
| 20 | 2 | 6.1 | 0.493 | 4.50 | 0.20 | 0.737 | 0.032 |
| 21 | 3 | 6.1 | 0.493 | 4.59 | 0.18 | 0.753 | 0.030 |
| 22 | 3 | 6.1 | 0.493 | 4.54 | 0.22 | 0.745 | 0.037 |
| 23 | 4 | 6.1 | 0.493 | 4.48 | 0.23 | 0.734 | 0.038 |
| 24 | 4 | 6.1 | 0.493 | 4.22 | 0.15 | 0.691 | 0.025 |
| 25 | 5 | 6.1 | 0.493 | 4.44 | 0.25 | 0.727 | 0.040 |
| 26 | 5 | 6.1 | 0.493 | 4.31 | 0.22 | 0.707 | 0.037 |
| 27 | 6 | 6.1 | 0.493 | 4.44 | 0.33 | 0.729 | 0.055 |
| 28 | 6 | 6.1 | 0.493 | 4.38 | 0.35 | 0.718 | 0.057 |
| 29 | 7 | 6.1 | 0.493 | 4.56 | 0.23 | 0.747 | 0.038 |
| 30 | 7 | 6.1 | 0.493 | 4.39 | 0.26 | 0.720 | 0.043 |
| 31 | 8 | 6.1 | 0.493 | 4.68 | 0.21 | 0.767 | 0.034 |
| 32 | 8 | 6.1 | 0.493 | 4.79 | 0.24 | 0.785 | 0.039 |

TABLE 7
Disc 979926-05-2

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 33 | 1 | 12 | 0.246 | 8.94 | 0.15 | 0.745 | 0.013 |
| 34 | 1 | 12 | 0.246 | 8.49 | 0.25 | 0.708 | 0.021 |
| 35 | 2 | 12 | 0.246 | 8.81 | 0.38 | 0.734 | 0.032 |
| 36 | 2 | 12 | 0.246 | 8.64 | 0.26 | 0.720 | 0.022 |
| 37 | 3 | 12 | 0.246 | 9.04 | 0.38 | 0.754 | 0.032 |
| 38 | 3 | 12 | 0.246 | 8.80 | 0.27 | 0.734 | 0.023 |
| 39 | 4 | 12 | 0.246 | 8.86 | 0.29 | 0.739 | 0.024 |
| 40 | 4 | 12 | 0.246 | 8.44 | 0.36 | 0.703 | 0.030 |
| 41 | 5 | 12 | 0.246 | 8.86 | 0.30 | 0.738 | 0.025 |
| 42 | 5 | 12 | 0.246 | 8.75 | 0.36 | 0.730 | 0.030 |
| 43 | 6 | 12 | 0.246 | 8.91 | 0.32 | 0.743 | 0.027 |
| 44 | 6 | 12 | 0.246 | 8.69 | 0.28 | 0.724 | 0.023 |
| 45 | 7 | 12 | 0.246 | 8.71 | 0.35 | 0.726 | 0.029 |
| 46 | 7 | 12 | 0.246 | 8.57 | 0.24 | 0.714 | 0.020 |
| 47 | 8 | 12 | 0.246 | 9.11 | 0.25 | 0.759 | 0.021 |
| 48 | 8 | 12 | 0.246 | 8.84 | 0.28 | 0.737 | 0.023 |

TABLE 8
Disc 979926-05-2

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 49 | 1 | 12 | 0.493 | 9.22 | 0.30 | 0.769 | 0.025 |
| 50 | 1 | 12 | 0.493 | 8.68 | 0.35 | 0.724 | 0.029 |
| 51 | 2 | 12 | 0.493 | 8.74 | 0.27 | 0.729 | 0.022 |
| 52 | 2 | 12 | 0.493 | 8.76 | 0.34 | 0.730 | 0.028 |
| 53 | 3 | 12 | 0.493 | 8.76 | 0.22 | 0.730 | 0.018 |
| 54 | 3 | 12 | 0.493 | 8.93 | 0.24 | 0.744 | 0.020 |
| 55 | 4 | 12 | 0.493 | 8.58 | 0.36 | 0.715 | 0.030 |
| 56 | 4 | 12 | 0.493 | 8.82 | 0.25 | 0.735 | 0.021 |
| 57 | 5 | 12 | 0.493 | 8.53 | 0.20 | 0.711 | 0.017 |
| 58 | 5 | 12 | 0.493 | 8.79 | 0.32 | 0.732 | 0.027 |
| 59 | 6 | 12 | 0.493 | 8.94 | 0.26 | 0.745 | 0.021 |
| 60 | 6 | 12 | 0.493 | 8.80 | 0.31 | 0.733 | 0.026 |
| 61 | 7 | 12 | 0.493 | 8.91 | 0.25 | 0.743 | 0.021 |
| 62 | 7 | 12 | 0.493 | 8.69 | 0.18 | 0.724 | 0.015 |
| 63 | 8 | 12 | 0.493 | 9.21 | 0.17 | 0.767 | 0.014 |
| 64 | 8 | 12 | 0.493 | 9.37 | 0.20 | 0.781 | 0.017 |

TABLE 9
Disc 979926-05-3

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 1 | 1 | 6.1 | 0.246 | 4.28 | 0.13 | 0.701 | 0.022 |
| 2 | 1 | 6.1 | 0.246 | 4.34 | 0.18 | 0.711 | 0.030 |
| 3 | 2 | 6.1 | 0.246 | 4.54 | 0.14 | 0.745 | 0.023 |
| 4 | 2 | 6.1 | 0.246 | 4.45 | 0.13 | 0.730 | 0.022 |
| 5 | 3 | 6.1 | 0.246 | 4.36 | 0.12 | 0.714 | 0.020 |
| 6 | 3 | 6.1 | 0.246 | 4.35 | 0.12 | 0.714 | 0.020 |
| 7 | 4 | 6.1 | 0.246 | 4.30 | 0.22 | 0.705 | 0.035 |
| 8 | 4 | 6.1 | 0.246 | 4.32 | 0.21 | 0.709 | 0.034 |
| 9 | 5 | 6.1 | 0.246 | 4.22 | 0.12 | 0.692 | 0.020 |
| 10 | 5 | 6.1 | 0.246 | 4.17 | 0.12 | 0.684 | 0.020 |
| 11 | 6 | 6.1 | 0.246 | 4.48 | 0.13 | 0.734 | 0.022 |
| 12 | 6 | 6.1 | 0.246 | 4.32 | 0.12 | 0.709 | 0.019 |
| 13 | 7 | 6.1 | 0.246 | 4.50 | 0.12 | 0.738 | 0.020 |
| 14 | 7 | 6.1 | 0.246 | 4.44 | 0.14 | 0.728 | 0.023 |
| 15 | 8 | 6.1 | 0.246 | 4.53 | 0.12 | 0.743 | 0.019 |
| 16 | 8 | 6.1 | 0.246 | 4.46 | 0.11 | 0.731 | 0.018 |

TABLE 10
Disc 979926-05-3

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 17 | 1 | 6.1 | 0.493 | 4.43 | 0.26 | 0.727 | 0.043 |
| 18 | 1 | 6.1 | 0.493 | 4.48 | 0.27 | 0.734 | 0.045 |
| 19 | 2 | 6.1 | 0.493 | 4.64 | 0.19 | 0.761 | 0.031 |
| 20 | 2 | 6.1 | 0.493 | 4.56 | 0.22 | 0.748 | 0.035 |
| 21 | 3 | 6.1 | 0.493 | 4.58 | 0.19 | 0.751 | 0.032 |
| 22 | 3 | 6.1 | 0.493 | 4.61 | 0.19 | 0.756 | 0.031 |
| 23 | 4 | 6.1 | 0.493 | 4.36 | 0.20 | 0.715 | 0.033 |
| 24 | 4 | 6.1 | 0.493 | 4.43 | 0.20 | 0.727 | 0.033 |
| 25 | 5 | 6.1 | 0.493 | 4.40 | 0.22 | 0.721 | 0.036 |
| 26 | 5 | 6.1 | 0.493 | 4.32 | 0.22 | 0.709 | 0.037 |
| 27 | 6 | 6.1 | 0.493 | 4.40 | 0.25 | 0.721 | 0.041 |
| 28 | 6 | 6.1 | 0.493 | 4.46 | 0.29 | 0.731 | 0.047 |
| 29 | 7 | 6.1 | 0.493 | 4.57 | 0.19 | 0.749 | 0.031 |
| 30 | 7 | 6.1 | 0.493 | 4.54 | 0.23 | 0.744 | 0.038 |
| 31 | 8 | 6.1 | 0.493 | 4.42 | 0.18 | 0.725 | 0.030 |
| 32 | 8 | 6.1 | 0.493 | 4.48 | 0.20 | 0.735 | 0.033 |

TABLE 11
Disc 979926-05-3

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 33 | 1 | 12 | 0.246 | 8.46 | 0.20 | 0.705 | 0.017 |
| 34 | 1 | 12 | 0.246 | 8.49 | 0.30 | 0.707 | 0.025 |
| 35 | 2 | 12 | 0.246 | 8.58 | 0.17 | 0.715 | 0.014 |
| 36 | 2 | 12 | 0.246 | 8.67 | 0.18 | 0.722 | 0.015 |
| 37 | 3 | 12 | 0.246 | 8.52 | 0.17 | 0.710 | 0.014 |
| 38 | 3 | 12 | 0.246 | 8.52 | 0.18 | 0.710 | 0.015 |
| 39 | 4 | 12 | 0.246 | 8.40 | 0.17 | 0.700 | 0.014 |
| 40 | 4 | 12 | 0.246 | 8.36 | 0.15 | 0.697 | 0.012 |
| 41 | 5 | 12 | 0.246 | 8.23 | 0.14 | 0.686 | 0.011 |
| 42 | 5 | 12 | 0.246 | 8.18 | 0.17 | 0.682 | 0.014 |
| 43 | 6 | 12 | 0.246 | 8.50 | 0.15 | 0.709 | 0.012 |
| 44 | 6 | 12 | 0.246 | 8.32 | 0.20 | 0.694 | 0.016 |
| 45 | 7 | 12 | 0.246 | 8.60 | 0.17 | 0.717 | 0.014 |
| 46 | 7 | 12 | 0.246 | 8.53 | 0.14 | 0.711 | 0.011 |
| 47 | 8 | 12 | 0.246 | 8.22 | 0.20 | 0.685 | 0.016 |
| 48 | 8 | 12 | 0.246 | 8.28 | 0.15 | 0.690 | 0.013 |

TABLE 12
Disc 979926-05-3

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 49 | 1 | 12 | 0.493 | 8.58 | 0.27 | 0.715 | 0.023 |
| 50 | 1 | 12 | 0.493 | 8.78 | 0.31 | 0.731 | 0.026 |
| 51 | 2 | 12 | 0.493 | 8.83 | 0.25 | 0.736 | 0.021 |
| 52 | 2 | 12 | 0.493 | 8.73 | 0.24 | 0.727 | 0.020 |
| 53 | 3 | 12 | 0.493 | 8.59 | 0.19 | 0.716 | 0.016 |
| 54 | 3 | 12 | 0.493 | 8.64 | 0.26 | 0.720 | 0.022 |
| 55 | 4 | 12 | 0.493 | 8.53 | 0.23 | 0.711 | 0.019 |
| 56 | 4 | 12 | 0.493 | 8.42 | 0.19 | 0.701 | 0.016 |
| 57 | 5 | 12 | 0.493 | 8.42 | 0.28 | 0.702 | 0.023 |
| 58 | 5 | 12 | 0.493 | 8.29 | 0.22 | 0.691 | 0.019 |
| 59 | 6 | 12 | 0.493 | 8.53 | 0.22 | 0.711 | 0.018 |
| 60 | 6 | 12 | 0.493 | 8.47 | 0.25 | 0.706 | 0.021 |
| 61 | 7 | 12 | 0.493 | 8.77 | 0.25 | 0.731 | 0.021 |
| 62 | 7 | 12 | 0.493 | 8.75 | 0.28 | 0.729 | 0.023 |
| 63 | 8 | 12 | 0.493 | 8.76 | 0.25 | 0.730 | 0.021 |
| 64 | 8 | 12 | 0.493 | 8.63 | 0.14 | 0.719 | 0.012 |

TABLE 13
Disc 979926-05-4

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 1 | 1 | 6.1 | 0.246 | 4.20 | 0.09 | 0.689 | 0.016 |
| 2 | 1 | 6.1 | 0.246 | 4.11 | 0.10 | 0.674 | 0.016 |
| 3 | 2 | 6.1 | 0.246 | 4.10 | 0.13 | 0.672 | 0.021 |
| 4 | 2 | 6.1 | 0.246 | 4.03 | 0.13 | 0.661 | 0.022 |
| 5 | 3 | 6.1 | 0.246 | 4.05 | 0.14 | 0.664 | 0.023 |
| 6 | 3 | 6.1 | 0.246 | 3.81 | 0.12 | 0.625 | 0.020 |
| 7 | 4 | 6.1 | 0.246 | 3.74 | 0.18 | 0.613 | 0.030 |
| 8 | 4 | 6.1 | 0.246 | 3.67 | 0.19 | 0.602 | 0.031 |
| 9 | 5 | 6.1 | 0.246 | 3.86 | 0.16 | 0.632 | 0.027 |
| 10 | 5 | 6.1 | 0.246 | 3.91 | 0.18 | 0.642 | 0.030 |
| 11 | 6 | 6.1 | 0.246 | 3.84 | 0.17 | 0.629 | 0.029 |
| 12 | 6 | 6.1 | 0.246 | 3.84 | 0.18 | 0.630 | 0.029 |
| 13 | 7 | 6.1 | 0.246 | 3.92 | 0.18 | 0.643 | 0.029 |
| 14 | 7 | 6.1 | 0.246 | 3.97 | 0.24 | 0.650 | 0.039 |
| 15 | 8 | 6.1 | 0.246 | 3.98 | 0.25 | 0.653 | 0.042 |
| 16 | 8 | 6.1 | 0.246 | 3.99 | 0.23 | 0.654 | 0.038 |

TABLE 14
Disc 979926-05-4

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 17 | 1 | 6.1 | 0.493 | 3.99 | 0.30 | 0.654 | 0.049 |
| 18 | 1 | 6.1 | 0.493 | 4.04 | 0.23 | 0.663 | 0.037 |
| 19 | 2 | 6.1 | 0.493 | 4.06 | 0.24 | 0.665 | 0.040 |
| 20 | 2 | 6.1 | 0.493 | 4.04 | 0.22 | 0.662 | 0.036 |
| 21 | 3 | 6.1 | 0.493 | 3.79 | 0.19 | 0.622 | 0.031 |
| 22 | 3 | 6.1 | 0.493 | 3.80 | 0.19 | 0.622 | 0.031 |
| 23 | 4 | 6.1 | 0.493 | 3.74 | 0.24 | 0.613 | 0.040 |
| 24 | 4 | 6.1 | 0.493 | 3.72 | 0.25 | 0.610 | 0.041 |
| 25 | 5 | 6.1 | 0.493 | 3.93 | 0.24 | 0.644 | 0.039 |
| 26 | 5 | 6.1 | 0.493 | 3.93 | 0.24 | 0.645 | 0.040 |
| 27 | 6 | 6.1 | 0.493 | 3.95 | 0.24 | 0.648 | 0.039 |
| 28 | 6 | 6.1 | 0.493 | 3.86 | 0.23 | 0.633 | 0.038 |
| 29 | 7 | 6.1 | 0.493 | 3.93 | 0.23 | 0.644 | 0.038 |
| 30 | 7 | 6.1 | 0.493 | 3.99 | 0.25 | 0.654 | 0.041 |
| 31 | 8 | 6.1 | 0.493 | 3.91 | 0.23 | 0.641 | 0.038 |
| 32 | 8 | 6.1 | 0.493 | 4.08 | 0.25 | 0.670 | 0.042 |

TABLE 15
Disc 979926-05-4

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 33 | 1 | 12 | 0.246 | 8.17 | 0.18 | 0.681 | 0.015 |
| 34 | 1 | 12 | 0.246 | 8.16 | 0.18 | 0.680 | 0.015 |
| 35 | 2 | 12 | 0.246 | 8.22 | 0.22 | 0.685 | 0.018 |
| 36 | 2 | 12 | 0.246 | 8.22 | 0.23 | 0.685 | 0.019 |
| 37 | 3 | 12 | 0.246 | 7.75 | 0.18 | 0.646 | 0.015 |
| 38 | 3 | 12 | 0.246 | 7.83 | 0.17 | 0.653 | 0.014 |
| 39 | 4 | 12 | 0.246 | 7.53 | 0.24 | 0.627 | 0.020 |
| 40 | 4 | 12 | 0.246 | 7.71 | 0.26 | 0.643 | 0.021 |
| 41 | 5 | 12 | 0.246 | 7.79 | 0.16 | 0.649 | 0.013 |
| 42 | 5 | 12 | 0.246 | 7.78 | 0.21 | 0.648 | 0.017 |
| 43 | 6 | 12 | 0.246 | 7.99 | 0.20 | 0.666 | 0.017 |
| 44 | 6 | 12 | 0.246 | 7.96 | 0.34 | 0.664 | 0.029 |
| 45 | 7 | 12 | 0.246 | 8.03 | 0.21 | 0.669 | 0.017 |
| 46 | 7 | 12 | 0.246 | 7.94 | 0.16 | 0.662 | 0.013 |
| 47 | 8 | 12 | 0.246 | 8.05 | 0.28 | 0.671 | 0.023 |
| 48 | 8 | 12 | 0.246 | 8.21 | 0.20 | 0.684 | 0.016 |

TABLE 16
Disc 979926-05-4

| | | | | Shear | | | |
|---|---|---|---|---|---|---|---|
| | | Down Force | Velocity | Force (lb_{f}) | | COF | |
| Run | Orientation | (lbf) | (m/min) | Average | STDEV | Average | STDEV |
| 49 | 1 | 12 | 0.493 | 8.13 | 0.22 | 0.678 | 0.018 |
| 50 | 1 | 12 | 0.493 | 8.10 | 0.24 | 0.675 | 0.020 |
| 51 | 2 | 12 | 0.493 | 8.06 | 0.27 | 0.672 | 0.023 |
| 52 | 2 | 12 | 0.493 | 7.92 | 0.22 | 0.660 | 0.018 |
| 53 | 3 | 12 | 0.493 | 7.84 | 0.24 | 0.654 | 0.020 |
| 54 | 3 | 12 | 0.493 | 7.78 | 0.21 | 0.648 | 0.018 |
| 55 | 4 | 12 | 0.493 | 7.85 | 0.22 | 0.654 | 0.018 |
| 56 | 4 | 12 | 0.493 | 7.73 | 0.21 | 0.644 | 0.018 |
| 57 | 5 | 12 | 0.493 | 7.77 | 0.30 | 0.648 | 0.025 |
| 58 | 5 | 12 | 0.493 | 7.83 | 0.31 | 0.652 | 0.026 |
| 59 | 6 | 12 | 0.493 | 7.95 | 0.22 | 0.663 | 0.019 |
| 60 | 6 | 12 | 0.493 | 7.78 | 0.21 | 0.649 | 0.017 |
| 61 | 7 | 12 | 0.493 | 8.05 | 0.22 | 0.671 | 0.018 |
| 62 | 7 | 12 | 0.493 | 7.97 | 0.21 | 0.664 | 0.018 |
| 63 | 8 | 12 | 0.493 | 8.07 | 0.24 | 0.673 | 0.020 |
| 64 | 8 | 12 | 0.493 | 8.16 | 0.25 | 0.680 | 0.021 |

### Effect of the Invention

Under most conditions, the coefficient of friction did not change significantly with changes in the load or the down force or with changes in the dragging velocity. The frictional force increased with the load or down force as expected. However, the frictional force did not change significantly at different dragging velocities. Under 6.1 lb and 0.246 m/min, the coefficient of friction for (Disc 979926-05-4 and Disc 979926-05-1 are about the same and these two are less than the coefficient of friction for Disc 979926-05-3 and Disc 979926-05-2 which are also about the same. Under 6.1 lb and 0.493 m/min, the coefficient of friction for Disc 979926-05-4 is less than that of Disc 979926-05-1 which in turn is less than that of Disc 979926-05-3. The coefficient of friction for Disc 979926-05-2 is about equal to that of Disc 979926-05-3. Under 12 lb and 0.246 m/min, the coefficient of friction for Disc 979926-05-4 is less than that of Discs 979926-05-1 and 979926-05-3 which in turn are less than that of Disc 979926-05-2. And finally, under 12 lb and 0.493 m/min, the coefficient of friction of Disc 979926-05-4 is less than that of Disc 979926-05-1 which is less than that of Disc 979926-05-3 which is less than that of Disc 979926-05-2.

This is interesting in that there is some change with discs and not all discs respond to increased load in the same way. It is also interesting to note based on average standard deviation figures that there is some degree of variation between discs as to the effects of orientation. However, runs with the same disc, load and orientation show a surprisingly good correlation suggesting that the results are indeed representative of an essential coefficient of friction characteristic and ultimately wearing or roughening capability of diamond conditioner discs.

### DETAILED DESCRIPTION OF THE DRAWINGS

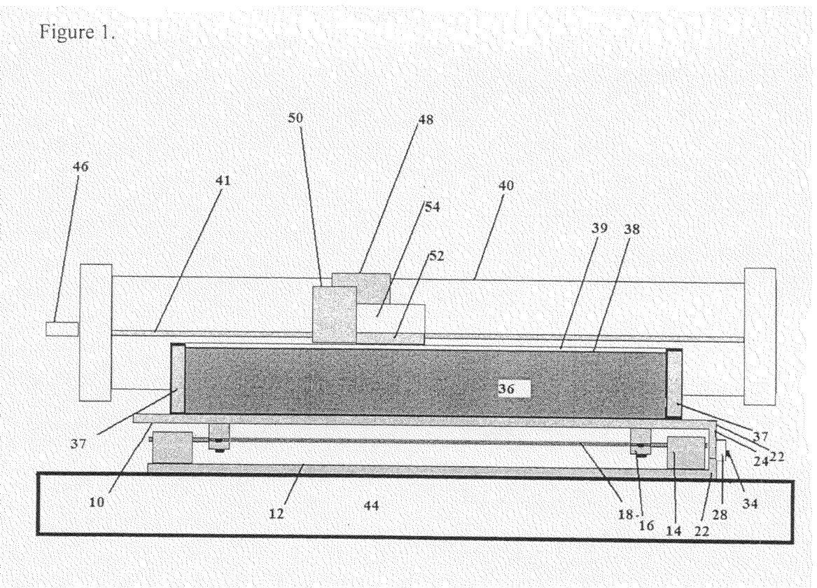

FIG. 1 is a side view of the device for the measurement of the coefficient of friction of diamond conditioner discs of the present invention.

10 is the bottom plate.

12 is the upper plate.

14 is the pillow blocks.

16 is the runner holders.

18 are the runners.

20 is the upward protrusion.

22 is the forward edge of the lower plate 12

24 is downward protrusion

25 are the guide blocks

26 is the forward edge of the upper plate 10.

28 is the load cell

30 are two half inch bolts.

32 is the sensory portion of the load cell.

34 is a half inch bolt

36 is the solid block of polished granite

37 are the brackets holding the granite block.

38 is the smooth polished upper surface of the granite block 36.

39 is the polycarbonate sheet.

40 Is a transverse movement device.

41 is the screw of the transverse movement device

42 is a support structure for the transverse movement device

44 is the lower surface to which the lower plate and the support structure for the transverse are attached.

46 is the cable connection to the stepper motor cable.

48 is the threaded block riding in the transverse/

50 is the concave surface securing the diamond conditioner disc.

52 is the diamond conditioner disc

54 is the load laid upon the diamond conditioner disc.

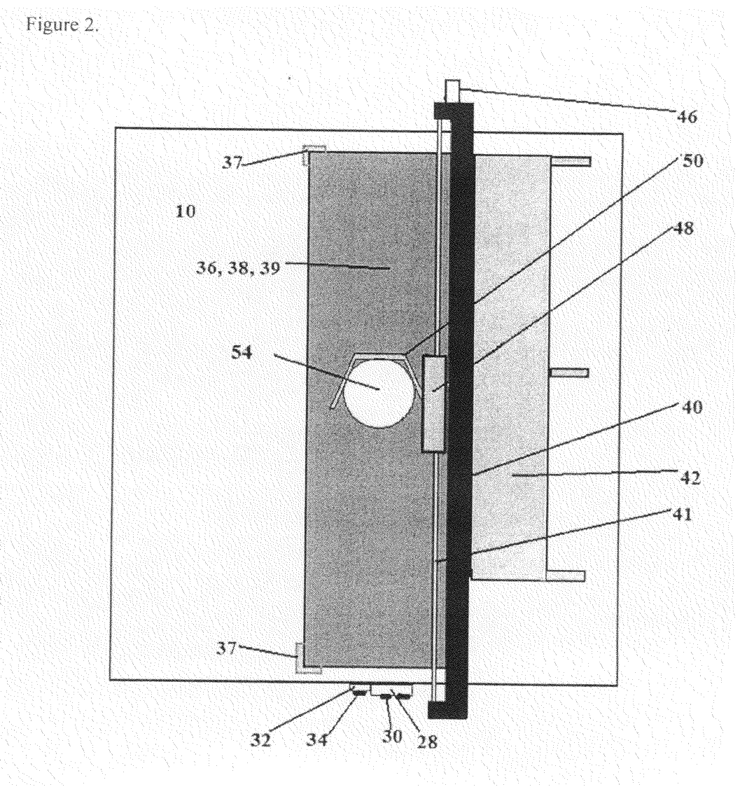

FIG. 2 is an end view of the device for the measurement of the coefficient of friction of diamond conditioner discs of the present invention.

FIG. 3 is a view from above of the device for the measurement of the coefficient of friction of diamond conditioner discs of the present invention.

1. A prime mover output control system comprising:
a deviation detection means for, with an output-power command value signal indicating a command value that is a target for the output power of a generator driven by a prime mover and an output-power signal indicating the present value of the output power as inputs, outputting a deviation signal indicating the deviation of the present value of the generator output power from the command value;
a control means for, with the deviation signal as input, outputting a control output signal for controlling the output of the prime mover; and
a filtering means for, in the output-power signal, the deviation signal, or the control output signal, attenuating or eliminating predetermined frequency components caused by periodic fluctuations in the generator output power, the predetermined frequency components occurring due to discrepancy between the output of the prime mover, and the generator output power.

2. A prime mover output control system comprising:
a deviation detection means for, with a rotating-speed command value signal indicating a command value that is a target for the rotating speed of a generator driven by a prime mover, and a rotating-speed signal indicating the present value of the rotating speed of the prime mover, as input, outputting a deviation signal indicating the deviation of the present value of the generator rotating speed from the command value;
a control means for, with the deviation signal as input, outputting a control output signal for controlling the output of the prime mover; and
a phase adjustment means for advancing or delaying the phase of the rotating-speed signal, the deviation signal, or the control output signal.

3. A prime mover output control system comprising:
a deviation detection means for, with an output-power command value signal indicating a command value that is a target for the output power of a generator driven by a prime mover, and an output-power signal indicating the present value of the output power, as input, for outputting a deviation signal indicating the deviation of the present value of the generator output power from the command value;
a control means for, with the deviation signal as input, outputting a control output signal for controlling the output of the prime mover;
a change detection means for, with the output-power signal as input, extracting from the output-power signal predetermined frequency components caused by periodic fluctuations in the generator output power, and outputting the extracted predetermined frequency components, the cycle fluctuation occurring due to discrepancy between the output of the prime mover and the output power;
a phase adjustment means for, with the predetermined frequency components as input, outputting a correction signal obtained from the predetermined frequency components by advancing or delaying the phase thereof; and
an addition means for adding the correction signal to the control output signal.

4. A prime mover output control system comprising:
a deviation detection means for, with a frequency signal indicating the present value of the frequency at the output terminal of a generator driven by a prime mover, or the frequency in a power system to which the generator is connected as input, outputting a deviation signal indicating the deviation of the frequency signal from a reference frequency, for the power system, that has been inputted from the outside, or stored in advance; and
a control means for, with the deviation signal as input, outputting a control output signal for controlling the output of the prime mover to suppress frequency fluctuation at the output terminal of the generator or at the power-system side.

5. The prime mover output control system according to claim 1, wherein, in place of the output-power signal, a rotating-speed signal indicating the present value of the rotating-speed of the prime mover is utilized, and in place of the output-power command value signal, a rotating-speed command value signal that is a target for the rotating-speed is utilized; or
wherein, in place of the output-power signal, a frequency signal is utilized that indicates the present value of the frequency at the output terminal of the generator driven by the prime mover, or the frequency in a power system to which the generator is connected, and in place of the output-power command value signal as input, a reference frequency for the power system is utilized, the reference frequency being inputted from the outside or having been stored in advance.

6. The prime mover output control system according to claim 3, wherein, in place of the output-power signal, a rotating-speed signal indicating the present value of the rotating-speed of the prime mover, or a frequency signal indicating the present value of the frequency at the output terminal of the generator driven by the prime mover, or the frequency in a power system to which the generator is connected, is utilized as input to the change detection means.

7. The prime mover output control system according to claim 3, wherein, for input to the deviation detection means, a rotating-speed signal indicating the present value of the rotating-speed of the prime mover is utilized in place of the output-power signal, and in place of the output-power command value signal, a rotating-speed command value that is a target for the rotating-speed is utilized; or
wherein, in place of the output-power signal, a frequency signal is utilized that indicates the present value of the frequency at the output terminal of a generator driven by a prime mover, or frequency in a power system to which the generator is connected, and in place of the output-power command value signal as input, a reference frequency for the power system is utilized, the reference frequency being inputted from the outside or having been stored in advance.

8. A prime mover output control system comprising:
a first switching means for, with a signal, as input, that indicates whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it has been determined that the connection does not exist;
a first deviation detection means for, with the signal that has been selected by the first switching means as an input, outputting a first deviation signal indicating the deviation of the input signal from the rotating-speed reference value or the frequency reference value;
a second deviation detection means for, with the frequency signal as input, outputting a second deviation signal indicating the deviation of the frequency signal from a reference frequency value that is inputted from the outside or has been stored in advance; and
a first control means for, with the first deviation signal as input, outputting a first control output signal for controlling the output of the prime mover.

9. The prime mover output control system according to claim 8,
wherein, when it is determined that the connection of the generator with the power system exists, the first switching means selects the second deviation signal, and, when it is determined that the connection does not exist, selects the first deviation signal.

10. A prime mover output control system comprising:
a first switching means for, with a signal, as input, that indicates whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it has been determined that the connection does not exist;
a first deviation detection means for, with the signal that has been selected by the first switching means as an input, outputting a first deviation signal indicating the deviation of the input signal from the rotating-speed reference value or the frequency reference value;
a first control means for, with the first deviation signal as input, outputting a first control output signal for controlling the output of the prime mover;
a second deviation detection means for, with a frequency signal as input, outputting a second deviation signal indicating the deviation of the frequency signal from a reference frequency value that is inputted from the outside or has been stored in advance; and
a second control means for, with the second deviation signal as input, outputting a second control output signal for controlling the output of the prime mover, wherein, the first switching means provides a control output signal by selecting the second deviation signal if it is determined that the connection of the generator with the power system exists, and the first control output signal if it is determined that the connection does not exist.

11. A prime mover output control system comprising:
a conversion means for outputting an equivalent signal obtained by converting a rotating-speed signal indicating the present value of the rotating-speed of a prime mover, which drives a generator, to be equivalent to the frequency of a power system with which the generator is connected;
a first switching means for, with a signal, as input, that indicates whether or not connection of the generator with the power system exists, selecting the rotating-speed signal if it is determined that the connection exists, and the equivalent signal if it is determined that the connection does not exist;
a deviation detection means for, with the signal that has been selected by the first switching means as input, outputting a deviation signal indicating the deviation of the input signal from the rotating-speed reference value or the frequency of the power system; and
a control means for, with the deviation signal that is outputted by the deviation detection means as input, outputting a control output signal for controlling the output of the prime mover.

12. A prime mover output control system comprising:
a deviation detection means for, with a rotating-speed signal indicating the present value of the rotating-speed of a prime mover as input, outputting a deviation signal indicating the deviation of the rotating-speed signal from a reference rotating-speed value that is inputted from the outside or has been stored in advance;
a conversion means for outputting an equivalent signal obtained by converting the deviation signal to be equivalent to the deviation of a frequency signal indicating the present value of the frequency of the power system from a reference frequency of a power system with which the generator is connected;
a first switching means for, with a signal indicating whether or not connection of a generator with the power system exists as input, selecting the deviation signal if it is determined that the connection exists, and the equivalent signal if it is determined that the connection does not exist; and
a control means for, with the signal that has been selected by the first switching means as input, outputting a control output signal for controlling the output of the prime mover.

13. The prime mover output control system according to claim 8, further comprising a filtering means for, in any one of signals created in the process from the input of the rotating-speed signal, or the frequency signal, to the output of the control output signal, attenuating or eliminating predetermined frequency components caused by periodic fluctuations, in the output power of the generator, that occur due to discrepancy between the output of the prime mover and the generator output power.

14. The prime mover output control system according to claim 8, further comprising a phase adjustment means for advancing or delaying the phase of any one of signals created in the process from the input of the rotating-speed signal, or the frequency signal, to the output of the control output signal.

15. A prime mover output control system comprising:
a first switching means for, with a signal, as input, that indicates whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the Present value of the rotating-speed of the prime mover if it has been determined that the connection does not exist;
a first deviation detection means for, with the signal that has been selected by the first switching means as an input, outputting a first deviation signal indicating the deviation of the input signal from the rotating-speed reference value or the frequency reference value;
a first control means for, with the first deviation signal as input, outputting a first control output signal for controlling the output of the prime mover;
a second switching means for, with as input a signal indicating whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it is determined that the connection does not exist;
a change detection means for, with the signal that has been selected by the second switching means as input, extracting from the output-power signal predetermined frequency components caused by periodic fluctuations in the output power of the generator, and outputting the extracted predetermined frequency components, the cycle fluctuation occurring due to discrepancy between the output of the prime mover and the output power of the generator;
a phase adjustment means for, with the predetermined frequency components as input, outputting a correction signal obtained from the predetermined frequency components by advancing or delaying the phase thereof; and
an addition means for adding the correction signal to the control output signal.

16. A prime mover output control system comprising:
a differentiation means for, by differentiating the deviation of the rotating-speeds of a prime mover that drives a generator, computing fluctuations, in the output power of the generator, that are caused by the deviation between the output of the prime mover and the output power of the generator, and outputting a compensation signal;
an addition means for adding the compensation signal to an output-power signal indicating the present value of the output power and outputting a prime mover output corresponding signal;
a deviation detection means for, with an output-power command value signal indicating a command value that is a target for the output power, and the prime mover output corresponding signal as inputs, outputting a deviation signal indicating the deviation of the present value of the output of the prime mover from the command value and;
a control means for, with the deviation signal as input, outputting a control output signal for controlling the output of the prime mover.

17. The prime mover output control system according to claim 16, further comprising a filtering means for attenuating or eliminating predetermined frequency components in the prime mover output corresponding signal, the deviation signal, or the control output signal.

18. The prime mover output control system according to claim 16, further comprising a phase adjustment means for advancing or delaying the phase of the prime mover output corresponding signal, the deviation signal, or the control output signal.

19. The prime mover output control system according to claim 16, further comprising:
a change detection means for, with the prime mover output corresponding signal as input, extracting predetermined frequency components from the input signal and outputting the extracted predetermined frequency components;
a phase adjustment means for, with the predetermined frequency components as input, outputting a correction signal obtained from the predetermined frequency components by advancing or delaying the phase thereof; and
an addition means for adding the correction signal to the control output signal.

20. A prime mover output control system comprising:
a deviation detection means for, with a reference frequency value indicating a reference frequency for a power system based on a generator driven by a prime mover, and a frequency signal indicating the present value of the frequency at an output terminal of the generator driven by the prime mover, as input, outputting a deviation signal indicating the deviation of the present value of the generator frequency signal from the reference frequency value;
a control means for, with the deviation signal as input, outputting a control output signal for controlling the output of the prime mover; and
a phase adjustment means for advancing or delaying the phase of the frequency signal, the deviation signal, or the control output signal,
the reference frequency being inputted from the outside or having been stored in advance.

21. The prime mover output control system according to claim 3, wherein, in place of the output-power signal, a rotating-speed signal indicating the present value of the rotating-speed of the prime mover is utilized, and in place of the output-power command value signal, a rotating-speed command value signal that is a target for the rotating-speed is utilized; or
wherein, in place of the output-power signal, a frequency signal is utilized that indicates the present value of the frequency at the output terminal of the generator driven by the prime mover, or the frequency in a power system to which the generator is connected, and in place of the output-power command value signal as input, a reference frequency for the power system is utilized, the reference frequency being inputted from the outside or having been stored in advance.

22. The prime mover output control system according to claim 9, further comprising a filtering means for, in any one of signals created in the process from the input of the rotating-speed signal, or the frequency signal, to the output of the control output signal, attenuating or eliminating predetermined frequency components caused by periodic fluctuations, in the output power of the generator, that occur due to discrepancy between the output of the prime mover and the generator output power.

23. The prime mover output control system according to claim 10, further comprising a filtering means for, in any one of signals created in the process from the input of the rotating-speed signal, or the frequency signal, to the output of the control output signal, attenuating or eliminating predetermined frequency components caused by periodic fluctuations, in the output power of the generator, that occur due to discrepancy between the output of the prime mover and the generator output power.

24. The prime mover output control system according to claim 11, further comprising a filtering means for, in any one of signals created in the process from the input of the rotating-speed signal, or the frequency signal, to the output of the control output signal, attenuating or eliminating predetermined frequency components caused by periodic fluctuations, in the output power of the generator, that occur due to discrepancy between the output of the prime mover and the generator output power.

25. The prime mover output control system according to claim 12, further comprising a filtering means for, in any one of signals created in the process from the input of the rotating-speed signal, or the frequency signal, to the output of the control output signal, attenuating or eliminating predetermined frequency components caused by periodic fluctuations, in the output power of the generator, that occur due to discrepancy between the output of the prime mover and the generator output power.

26. The prime mover output control system according to claim 9, further comprising a phase adjustment means for advancing or delaying the phase of any one of signals created in the process from the input of the rotating-speed signal, or the frequency signal, to the output of the control output signal.

27. The prime mover output control system according to claim 10, further comprising a phase adjustment means for advancing or delaying the phase of any one of signals created in the process from the input of the rotating-speed signal, or the frequency signal, to the output of the control output signal.

28. The prime mover output control system according to claim 11, further comprising a phase adjustment means for advancing or delaying the phase of any one of signals created in the process from the input of the rotating-speed signal, or the frequency signal, to the output of the control output signal.

29. The prime mover output control system according to claim 12, further comprising a phase adjustment means for advancing or delaying the phase of any one of signals created in the process from the input of the rotating-speed signal, or the frequency signal, to the output of the control output signal.

30. The prime mover output control system according to claim 9, further comprising:
a second switching means for, with as input a signal indicating whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it is determined that the connection does not exist;
a change detection means for, with the signal that has been selected by the second switching means as input, extracting from the output-power signal predetermined frequency components caused by periodic fluctuations in the output power of the generator, and outputting the extracted predetermined frequency components, the cycle fluctuation occurring due to discrepancy between the output of the prime mover and the output power of the generator;
a phase adjustment means for, with the predetermined frequency components as input, outputting a correction signal obtained from the predetermined frequency components by advancing or delaying the phase thereof; and
an addition means for adding the correction signal to the control output signal.

31. The prime mover output control system according to claim 10, further comprising:
a second switching means for, with as input a signal indicating whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it is determined that the connection does not exist;
a change detection means for, with the signal that has been selected by the second switching means as input, extracting from the output-power signal predetermined frequency components caused by periodic fluctuations in the output power of the generator, and outputting the extracted predetermined frequency components, the cycle fluctuation occurring due to discrepancy between the output of the prime mover and the output power of the generator;
a phase adjustment means for, with the predetermined frequency components as input, outputting a correction signal obtained from the predetermined frequency components by advancing or delaying the phase thereof; and
an addition means for adding the correction signal to the control output signal.

32. The prime mover output control system according to claim 11, further comprising:
a second switching means for, with as input a signal indicating whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it is determined that the connection does not exist;
a change detection means for, with the signal that has been selected by the second switching means as input, extracting from the output-power signal predetermined frequency components caused by periodic fluctuations in the output power of the generator, and outputting the extracted predetermined frequency components, the cycle fluctuation occurring due to discrepancy between the output of the prime mover and the output power of the generator;
a phase adjustment means for, with the predetermined frequency components as input, outputting a correction signal obtained from the predetermined frequency components by advancing or delaying the phase thereof; and
an addition means for adding the correction signal to the control output signal.

33. The prime mover output control system according to claim 12, further comprising:
a second switching means for, with as input a signal indicating whether or not connection of a generator driven by a prime mover with a power system is implemented, selecting a frequency signal indicating the present value of the frequency at the output terminal of the generator, or the frequency in a power system if it is determined that the connection exists, and selecting a rotating-speed signal indicating the present value of the rotating-speed of the prime mover if it is determined that the connection does not exist;
a change detection means for, with the signal that has been selected by the second switching means as input, extracting from the output-power signal predetermined frequency components caused by periodic fluctuations in the output power of the generator, and outputting the extracted predetermined frequency components, the cycle fluctuation occurring due to discrepancy between the output of the prime mover and the output power of the generator;
a phase adjustment means for, with the predetermined frequency components as input, outputting a correction signal obtained from the predetermined frequency components by advancing or delaying the phase thereof; and
an addition means for adding the correction signal to the control output signal.
